(19) United States
(12) Patent Application Publication
(10) Pub. No.: US 2011/0076894 A1
(43) Pub. Date: Mar. 31, 2011

(54) LOWER PROFILE ELECTRICAL SOCKET CONFIGURED WITH WAFERS

(75) Inventors: SHUO-HSIU HSU, Tu-Cheng (TW); JIA-HAU LIU, Tu-Cheng (TW)

(73) Assignee: HON HAI PRECISION INDUSTRY CO., LTD., Tu-Cheng (TW)

(21) Appl. No.: 12/892,938

(22) Filed: Sep. 29, 2010

(30) Foreign Application Priority Data
Sep. 30, 2009 (TW) 98218018

(51) Int. Cl. H01R 24/00

(52) U.S. Cl. 439/660

(57) ABSTRACT

The present invention relates to an electrical socket comprising a plurality of wafers arranged with one another in a first direction in a parallel relation, and a constraining device holding the wafers in position so as to maintain the wafers in a parallel manner. Each wafer is molded by an injected art with a number of contacts molded therein.

### BACKGROUND OF THE INVENTION

1. Field of the Invention

The present invention relates to the art of electrical socket. Specially, the present invention provides a lower profile electrical socket with wafers assembled therein each having a number of contacts located therein from art of insertion molding.

2. Description of Prior Art

Generally speaking, a socket to which the present invention is related is interposed between a first and a second electronic part or components having contact pads, respectively, to achieve electrical connection between the first and the second electronic components. In the following description, the first and the second electronic components are directed to a printed board and a Large Scale Integrated circuit (LSI), respectively. The socket comprises an insulative housing provided with a plurality of contact receptacle holes penetrating the insulator in a thickness direction, and a plurality of elastic contacts inserted into and held in the contact receptacle holes, respectively. In the conventional electrical connectors, housings are usually molded by an injection molding art.

As a result, after the socket is formed, contacts are inserted in a column-row configuration on the housing of the electrical connector. In addition, when the industry trend is to obtain highest quantity of contacts on the electrical socket, the housing of the electrical socket needs to receive more terminals therein for getting a better electrical connection and transmitting more signals, the number of passageways formed on the housing needs be increased correspondingly which leads the housing difficultly to be molded. Moreover, the conventional socket cannot meet need of trend of miniaturization and multiple contact points freely. Moreover, in order to get a contact layout of miniaturization and multiple contact points, multiple contacts need to be inserted into the original housing. Obviously, the traditional contact insertion process can be hardly used in the fine pitch and low profile socket connector.

In view of the above, an improved electrical socket that overcomes the above-mentioned disadvantages is desired.

### SUMMARY OF THE INVENTION

Accordingly, an object of the present invention is to provide an electrical socket with a plurality of wafers assembled therein. Each wafer has a number of contacts molded therein from an injected art.

To achieve the above-mentioned object, The present invention relates to an electrical socket comprising a plurality of wafers arranged with one another in a first direction and in a parallel relation, and a constraining device holding the wafers in position so as to maintain said wafers in a parallel manner. Each wafer is molded by an injected art with a number of contacts molded therein.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric, assembled view of an electrical socket in accordance with a preferred embodiment of the present invention;

FIG. 2 is similar to FIG. 1 showing an assembled view of the electrical socket of the present invention from another view;

FIG. 3 is an isometric, exploded view of the electrical socket of FIG. 1;

FIG. 4 is an isometric, exploded view of the electrical socket of FIG. 2;

FIG. 5 is an isometric view showing a contact strip with a number of contacts thereon;

FIG. 6 is an isometric view showing a wafer having a contact strip being ready to be assembled with a frame of the electrical socket of the present invention; and

FIG. 7 is a top view of the electrical socket of FIG. 1.

### DETAILED DESCRIPTION OF THE PREFERRED EMBODIMENT OF THE INVENTION

Reference will now be made to the drawings to describe the present invention in detail.

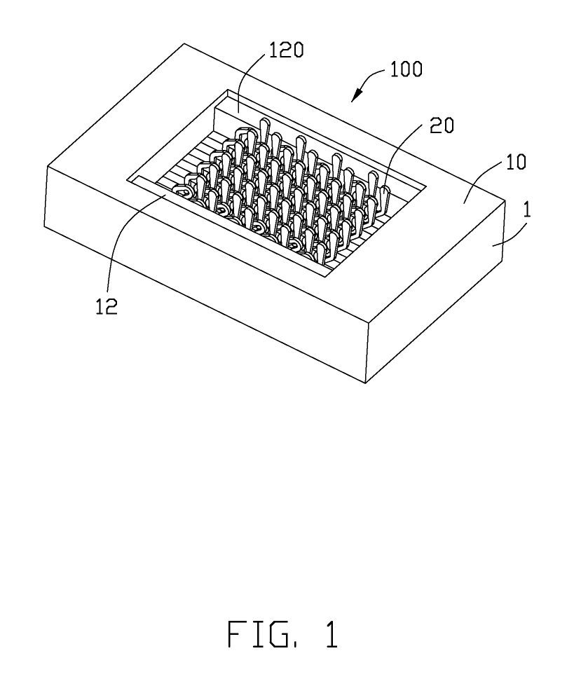

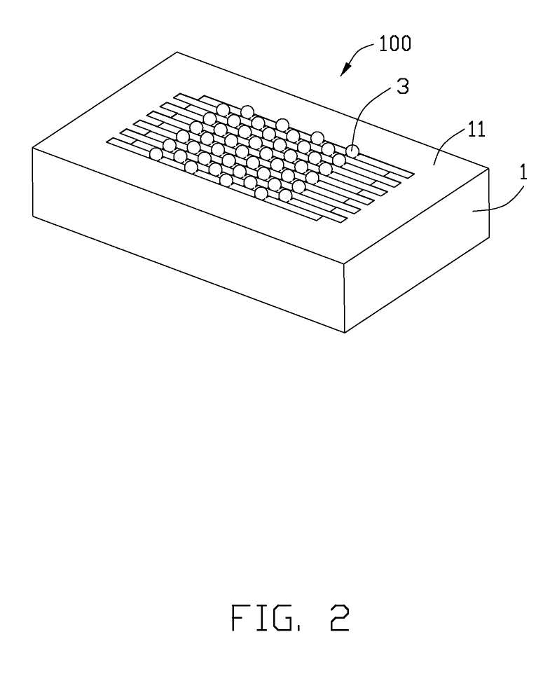

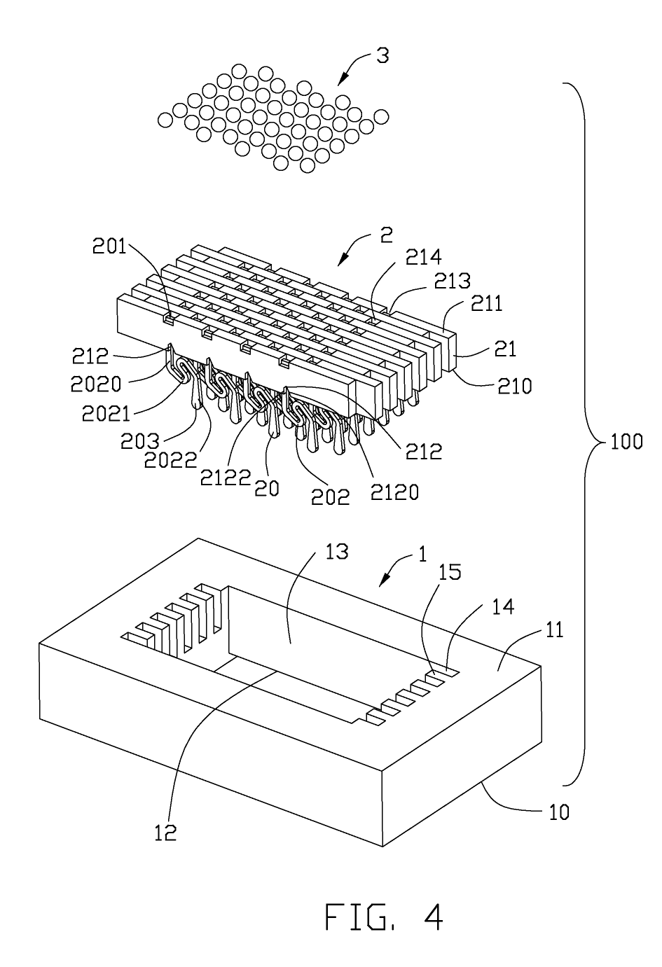

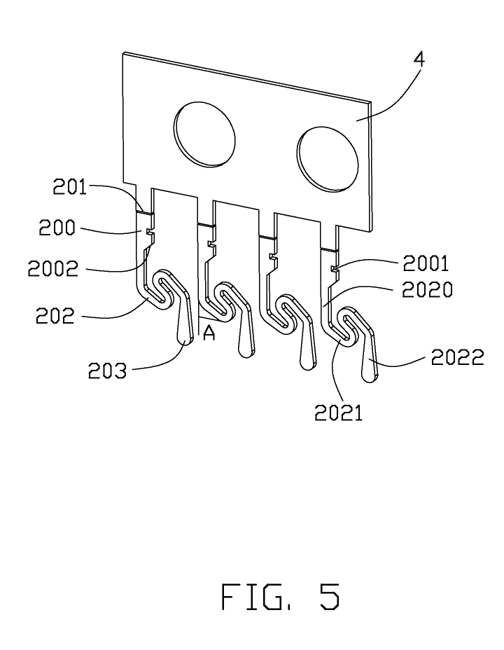

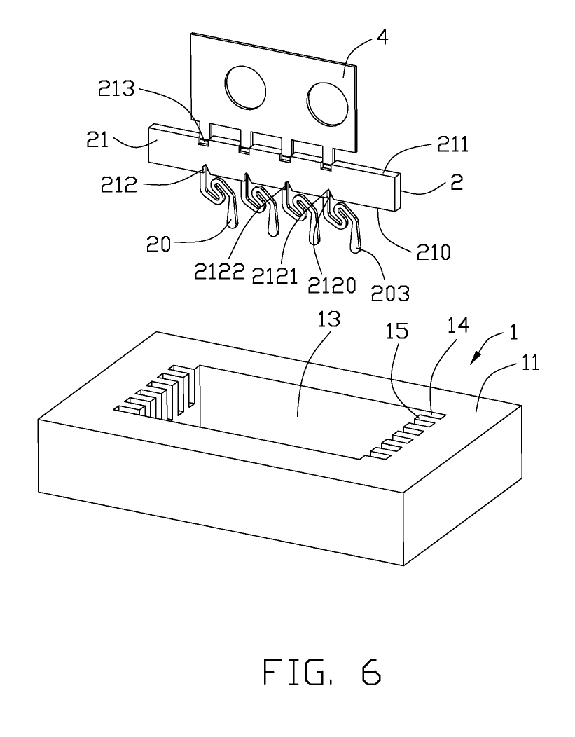

Referring to FIGS. 1-6, the electrical socket 100 of the present invention is used for electrically connecting an LSI package (not shown) to a PCB (not shown), comprising a frame 1, a plurality of wafers 2 each molded with a plurality of contacts 20 therein. Each contact 20 has a solder ball 3 attached on a bottom portion thereon. The solder ball 3 will be soldered on the bottom portion of the contact 20 after the wafers 2 are assembled into the frame.

Referring to FIGS. 1-4, the frame 1 defines an upper face 10, a lower face 11 opposite to the upper face 10. A supporting portion 12 is recessed downward from a middle portion of the upper face 10. The supporting portion 12 defines a supporting surface 120 below the upper face 10 of the frame 1 in an up-to-down direction. The supporting portion 12 further defines an opening 12 through both the supporting surface 120 and the lower face 11. The opening 12 defines a plurality of slots 14 at opposite inner walls thereof. Correspondingly, a plurality of interior walls 15 is formed between two adjacent slots 14.

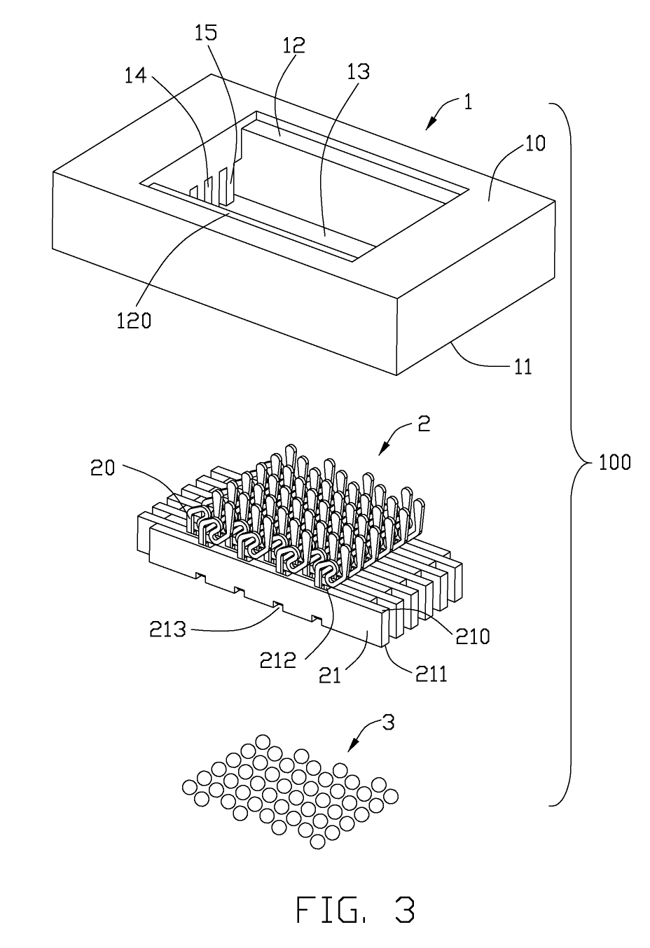

Referring to FIGS. 3-6, each wafer 2 has a base 21 with a plurality of contacts 20 received therein. The contacts 12 and the corresponding base are integrated molded by an injection art. The contacts 12 are formed by art of stamping from a contact strip 4 before molded with the base 21.

Each contact 20 comprises a retaining portion 200 extending in a vertical direction, a solder portion 201 formed at a bottom portion of the retaining portion 200, a first arm extending upwardly from a side of a top end of the retaining portion 200, a curving second arm 2021, and a third arm 2022 extending upwardly from the second arm 2021. A contacting portion 203 is formed at a tail end of the third arm 2022 for engaging with the LSI package. A notch 2001 is formed at a middle portion of an edge of the retaining portion 200 and a slanting surface 2002 extending toward the first arm 2020 is formed at an edge of the top end of the retaining portion 200. The second arm 2021 has a top end A, which is higher than the supporting surface 120 of the frame 1 when the contacts 12 is received in the frame 1.

In an assembly process, at first, the base 21 and a plurality of contacts 12 form the wafer by injection molding art. A sloping surface 212 is formed on an upper surface 210 of the base 21. The base 21 further defines an opening 213 recessed both from one of sidewalls and the lower surface 211 of the base 21. Secondly, the plurality of wafers 2 is inserted into the slots 14 of the frame 1 from a lower face 11, respectively. At last, the contact strips 4 are cut off and removed from corresponding wafers 2.

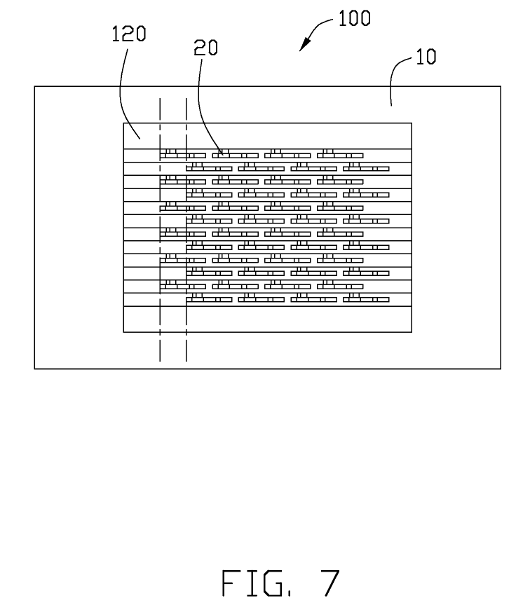

After the assembled process done, the top end A of the contact 12 extend beyond the supporting surface 120 for engaging with the IC package. The plurality of wafer 2 is arranged with one another in a first direction in a parallel relation. All contacts 12 are arranged in rows along the first direction and columns along a second direction perpendicular to the first direction. Referring to FIG. 7, all contacts are arranged in a manner of one contact of corresponding row offset from an adjacent contact of an adjacent corresponding row in the column direction. Specially, the one contact of corresponding row is aligned with another contact of anther corresponding row in the column direction, which is neighboring the adjacent corresponding row. In another word, after the assembling process is done, the wafers 2 are grouped with a first type and a second type. The contacts in a wafer 2 of a first type are offset from contacts located in a wafer 2 of a second type along the second direction in each column. Moreover, the wafers of first type and second type are alternately arranged with one another in the column direction. Accordingly, referring to FIGS. 1 and 3, a solder cavity is formed by the opening 213 and sidewall of an adjacent wafer 2.

According to the present invention, the socket holds the contacts by the wafers. The contacts and the wafer are formed from the insertion-molding process. As we know, there are no passageways for receiving the contacts in such wafer. Thus, a high density of layout of the contacts may be achieved easily by such art. Accordingly, an electrical socket having a high-density contacts layout is provided.

While the preferred embodiment in accordance with the present invention has been shown and described, equivalent modifications and changes known to persons skilled in the art according to the spirit of the present invention are considered within the scope of the present invention as defined in the appended claims.

What is claimed is:

1. An electrical socket, comprising:
a plurality of wafers arranged with one another in a first direction in a parallel relation, each wafer molded by an injection molding art with a number of contacts molded therein;
a constraining device holding the wafers in position so as to maintain said wafers in a parallel manner; and wherein
the wafers are grouped with a first type and a second type alternately arranged with each other in the first direction, the wafers of a first type being offset from a wafer of a second type such that making the wafers forming an interstitial matrix.

2. The electrical socket as claimed in claim 1, wherein the constraining device defines a receiving cavity therein.

3. The electrical socket as claimed in claim 2, wherein the constraining device defines a plurality of slots on opposite inner walls of the receiving cavity respectively, for receiving the plurality of wafers.

4. The electrical socket as claimed in claim 1, wherein all contacts in the wafers are arranged in rows along the first direction and columns along a second direction perpendicular to the first direction.

5. The electrical socket as claimed in claim 4, wherein the contacts are arranged in a manner that one contact of corresponding row is offset from an adjacent contact of an adjacent corresponding row in the column direction.

6. The electrical socket as claimed in claim 5, wherein the one contact of corresponding row is aligned with another contact of anther corresponding row in the column direction, which is neighboring the adjacent corresponding row.

7. The electrical socket as claimed in claim 6, wherein the plurality of contacts received in a corresponding wafer extends along the first direction.

8. An electrical socket, comprising:
a frame having a receiving cavity therein, the receiving cavity defining a plurality of slots;
a number of wafers received in the corresponding slots of receiving cavity, each wafer having a number of contacts received therein; wherein
all contacts in the wafers are arranged in rows along a first direction and columns along a second direction perpendicular to the first direction; and wherein
the contacts are arranged in a manner that one contact of corresponding row offset from an adjacent contact of an adjacent corresponding row in column direction.

9. The electrical socket as claimed in claim 8, wherein the one contact of corresponding row is aligned with another contact of anther corresponding row in the column direction, which is neighboring the adjacent corresponding row.

10. The electrical socket as claimed in claim 8, wherein each wafer defines an upper face, a lower face opposite to the upper face and sidewalls interconnecting the two faces.

11. The electrical socket as claimed in claim 10, wherein each wafer defines an opening recessed both from one of sidewalls and the lower face thereof but not through the corresponding sidewall.

12. The electrical socket as claimed in claim 11, wherein a solder ball is received in the opening and positioned by the opening and an adjacent wafer.

13. The electrical socket as claimed in claim 8, wherein the plurality of contacts received in a corresponding wafer and the corresponding wafer are integrally molded by an injected art.

14. An electrical socket comprising:
a plurality of wafers each extending in a lengthwise direction while all stacked upon one another in a lateral direction perpendicular to said lengthwise direction; and
a plurality of contacts disposed in each of said wafers so as to form a matrix arrangement on all said wafers; wherein
tails of said contacts between every adjacent to wafers are arranged in a staggered manner in said lengthwise direction under condition that a bottom face of each of said wafer defines a plurality of openings to receive the corresponding tails of the contacts, and each of said openings is restrained by the two neighboring wafers in the lateral direction so as to hold a corresponding solder ball therein.

15. The electrical socket as claimed in claim 14, wherein each of said contacts includes an upper resilient contacting portion which is not aligned with the corresponding tail in a vertical direction perpendicular to both said lengthwise direction and said lateral direction.

16. The electrical socket as claimed in clam 15, wherein the contacting portions of said contacts in each of said wafers are staggered with those of the neighboring wafers in said lengthwise direction.

17. The electrical socket as claimed in claim 14, wherein the wafer is offset from the neighboring wafers in the lengthwise direction.

18. The electrical socket as claimed in claim 17, wherein each of said wafers is individually fastened to a frame in which all said wafers are received.

19. The electrical socket as claimed in claim 14, wherein the contact is aligned with while spaced from the neighboring contact of the same wafer with a distance in the lengthwise direction, and is aligned with while spaced from another neighboring contact of a second neighboring wafer with the same distance in the lateral direction.
